(19) United States
(12) Patent Application Publication
(10) Pub. No.: US 2019/0363603 A1
(43) Pub. Date: Nov. 28, 2019

(54) AIR-COOLED RAINPROOF MOTOR STRUCTURE

(71) Applicant: GP Enterprises Co., Ltd., Suzhou (CN)

(72) Inventor: Xian Wang, Suzhou (CN)

(21) Appl. No.: 16/417,638

(22) Filed: May 20, 2019

Related U.S. Application Data
(63) Continuation of application No. PCT/CN2018/091314, filed on Jun. 14, 2018.

(30) Foreign Application Priority Data
May 25, 2018 (CN) 201820795594.3

(51) Int. Cl. H02K 5/10; H02K 9/06

(52) U.S. Cl. CPC H02K 5/10; H02K 2205/09; H02K 9/06

(57) ABSTRACT

An air-cooled rainproof motor structure includes a front end cover, a motor housing, a motor stator, a motor rotor, a shaft, a rear end cover, an axial fan and a fan housing. The motor stator and the motor rotor are arranged inside the motor housing; the motor rotor is arranged inside the motor stator; the axial fan is connected with the rear end cover through the shaft; the axial fan is surrounded by the fan housing; the front end cover is provided with vent holes and the rear end cover is also provided with a vent hole. The front end cover includes: a pump connection side, a motor connection side and a middle part. Through the above method, the air-cooled rainproof motor structure provided not only plays a protection role against rain, but also has a good heat dissipation effect.

### CROSS REFERENCE TO RELATED APPLICATIONS

The present application is a Continuation Application of PCT Application No. PCT/CN2018/091314 filed on Jun. 14, 2018, which claims the benefit of Chinese Patent Application No. 201820795594.3 filed on May 25, 2018. All the above are hereby incorporated by reference.

### FIELD OF THE INVENTION

The invention relates to the field of machining and manufacturing of household pumps, and more particularly relates to an air-cooled rainproof motor structure.

### BACKGROUND OF THE INVENTION

At present, many of household pumps use enclosed motor structure due to the rainproof requirement. However, the enclosed motor structure normally adopts a centrifugal fan to cool down the motor housing, so the heat dissipation effect is poor as the motor is enclosed. In order to overcome the defects in prior art, the motor size has to be enlarged, which increases the cost. Solutions that blow hot air out of motors are available from the market at present, but the motor structure is unenclosed, which cannot be applied in scenarios requiring protection against rain, or customers have to add an extra rainproof device on the motor, which significantly increases the production cost and installation size.

### SUMMARY OF THE INVENTION

The invention is to overcome the above-mentioned technical disadvantages and provide an air-cooled rainproof motor structure with good heat dissipation.

To solve these problems mentioned above, a technical solution adopted by the invention is to provide an air-cooled rainproof motor structure, which comprises a front end cover, a motor housing, a motor stator, a motor rotor, a shaft, a rear end cover, an axial fan and a fan housing. The motor stator and the motor rotor are arranged inside the motor housing; the motor rotor is arranged inside the motor stator; the front end cover is connected with the front end of the motor housing through the shaft; the rear end cover is connected with the back end of the motor housing through the shaft; the axial fan is connected with the rear end cover through the shaft; the axial fan is surrounded by the fan housing; the front end cover is provided with vent holes which comprise a first vent hole and a second vent hole; and the rear end cover is also provided with vent holes. The front end cover comprises a pump connection side, a motor connection side and a middle part.

In a preferred embodiment of the invention, the axial fan blows cold air through the vent hole of the rear end cover into the motor so as to cool down the motor stator and the motor rotor directly, after which the hot air is discharged from the vent holes of the front end cover.

In a preferred embodiment of the invention, part of the cold air is directly blown onto the motor housing, so as to cool down the motor housing.

In a preferred embodiment of the invention, the middle part of the front end cover is provided with a rainproof baffle, and a drainage hole is arranged on the bottom of the middle part.

In a preferred embodiment of the invention, the middle part of the front end cover is provided with a second vent hole, so as to discharge the hot air from the motor.

In a preferred embodiment of the invention, the motor connection side of the front end cover is provided with a first vent hole, so as to discharge the hot air from the motor.

In a preferred embodiment of the invention, the rear end of the fan housing is provided with a third vent hole.

In a preferred embodiment of the invention, a hole is arranged on the bottom of the fan housing.

The beneficial effects of the invention are as follows: an air-cooled rainproof motor structure disclosed in the invention changes the front and rear end covers of traditional motors from the enclosed structure to a structure with vent holes, and also replaces the centrifugal fan by an axial fan. In this way, on one hand, the axial fan can blow cold air into the motor so as to cool down the motor stator and the motor rotor and discharge hot air from the vent holes of the front end cover. On the other hand, part of the cold air is blown onto the motor housing for cooling inside and outside at the same time for good heat dissipation effect, like a centrifugal fan did. A rainproof baffle is provided to guide the rainwater to flow down, keep away from the air outlet and flow out through the drainage holes. In addition, a hole is arranged on the bottom of motor housing and a first vent hole and a second vent hole are arranged on the front end cover. Based upon this structural design, the rainproof requirement of the motor can be satisfied.

### BRIEF DESCRIPTION OF THE DRAWINGS

In order to more clearly illustrate the technical solutions in the embodiments of the invention, the drawings which have to be used in an embodiment will be briefly introduced hereinafter. These and other aspects of the subject invention will become readily apparent to those of ordinary skill in the art from the following detailed description together with the drawings. Other drawings can be obtained from these drawings without creative work.

FIG. 1 shows an exploded view of the air-cooled rainproof motor structure;

FIG. 2 shows a section view of the air-cooled rainproof motor structure;

FIG. 3 shows the front view of the front end cover of the air-cooled rainproof motor structure;

FIG. 4 shows a three-dimensional view of the front end cover of the air-cooled rainproof motor structure;

FIG. 5 shows another three-dimensional view of the front end cover of the air-cooled rainproof motor structure;

FIG. 6 shows the front view of the front end cover of the air-cooled rainproof motor structure;

FIG. 7 shows a three-dimensional view of the rear end cover of the air-cooled rainproof motor structure;

FIG. 8 shows the front view of the fan housing of the air-cooled rainproof motor structure;

FIG. 9 shows a three-dimensional view of the fan housing of the air-cooled rainproof motor structure;

### DETAILED DESCRIPTION

The following clearly and completely describes the technical solutions in the embodiments of the invention. Apparently, the described embodiments are only part of the embodiments of the invention and not all embodiments. Based on the embodiments illustrated by the invention, all other embodiments obtained by those of ordinary skill in the art without creative works are within the scope of protection of the invention.

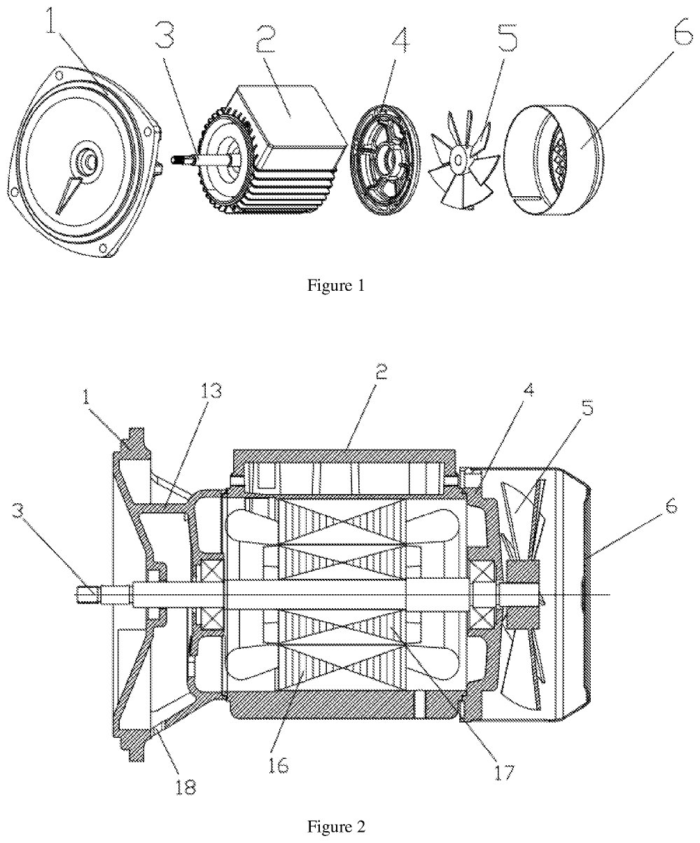

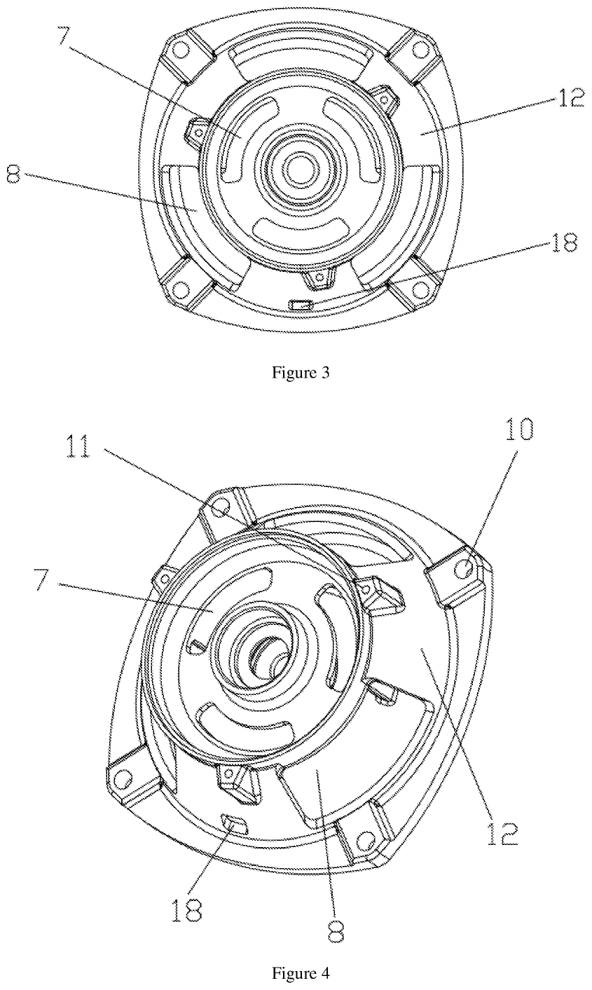

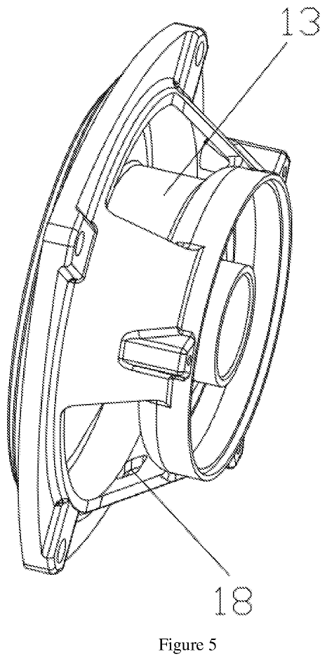

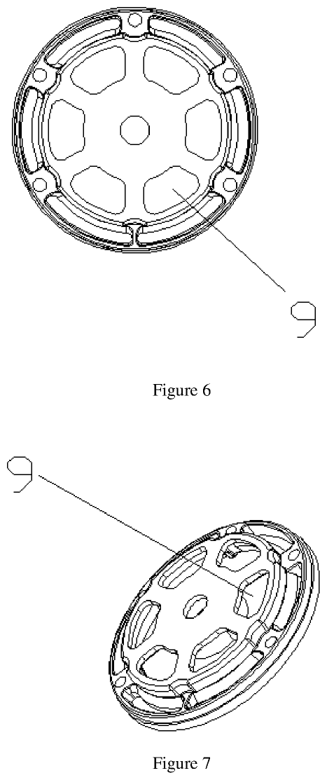

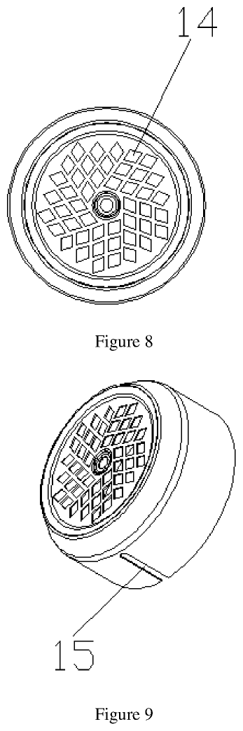

By referring to FIG. 1-9, the embodiments of the invention include:

An air-cooled rainproof motor structure, comprising: a front end cover 1, a motor housing 2, a motor stator 16, a motor rotor 17, a shaft 3, a rear end cover 4, an axial fan 5 and a fan housing 6. The motor stator 16 and the motor rotor 17 are arranged inside the motor housing 2; the motor rotor 17 is arranged inside the motor stator 16; the front end cover 1 is connected with the front end of the motor housing 2 through the shaft 3; the rear end cover 4 is connected with the back end of the motor housing 2 through the shaft 3; the axial fan 5 is connected with the rear end cover 4 through the shaft 3; the axial fan 5 is surrounded by the fan housing 6; the front end cover 1 is provided with vent holes which comprise a first vent hole 7 and a second vent hole 8; and the rear end cover 4 is also provided with a vent hole 9.

The axial fan 5, on the one hand, first blows cold air through the vent hole 9 of the rear end cover 4 into the motor housing 2 so as to cool down the motor stator 16 and the motor rotor 17 directly, after which the hot air is discharged from the vent holes of the front end cover 1. On the other hand, part of the cold air is blown onto the motor housing to cool inside and outside at the same time for good heat dissipation effect, like a centrifugal fan did. A traditional centrifugal fan can only blow air onto the motor housing and the cold air only contacts with the motor housing 2 to dissipate heat, so the heat dissipation effect is very poor.

The front end cover 1 comprises three parts: a pump connection side 10, a motor connection side 11 and a middle part 12. Wherein the pump connection side 10 is connected with a pump; the motor connection side 11 is connected with the front end of motor housing 2; the motor connection side 11 is provided with the first vent hole 7; the middle part 12 plays a role as heat dissipation and supporting; the middle part 12 is provided with a rainproof baffle 13, which has an arc structure and is arranged above the first vent hole 7; a drainage hole 18 is arranged on the bottom of the middle part and the rainproof baffle 13 is to guide the rainwater to flow down, keep away from the air outlet and flow out through the drainage hole; the middle part 12 is also provided with the second vent hole 8, which can not only meet the rainproof requirement and prevent water from flowing into the motor, but also have good heat dissipation effect. Solutions that blow hot air out of motors are available from the market at present, but the motor structure is unenclosed, which cannot be applied in scenarios requiring protection against rain or customers have to add an extra rainproof device on the motor, which significantly increases the production cost and installation size and restricts the scope of application. The invention adopts a new type of motor structure with no need to add an additional rainproof device, which reduces the installation size and the production cost and extends the application scope.

The fan housing 6 is provided with a third vent hole 14 on the rear side, which is designed to keep fingers out and thus improve the safety of the motor.

The fan housing 6 is provided with a hole 15 on the bottom which is used to drain water easily. By this design, even small amount of water flowing inside will be drained through the hole 15 on the fan housing 6, which prevents it from going into the motor and keeps motor running safely.

In summary, an air-cooled rainproof motor structure disclosed in the invention changes the front and rear end covers of traditional motors from the enclosed structure to a structure with vent holes, and also replaces the centrifugal fan by an axial fan. In this way, on one hand, the axial fan can blow cold air into the motor so as to cool down the motor stator and the motor rotor and discharge hot air from the vent holes of the front end cover. On the other hand, part of the cold air is blown onto the motor housing for cooling inside and outside at the same time for good heat dissipation effect, like a centrifugal fan did. A rainproof baffle is provided to guide the rainwater to flow down, keep away from the air outlet and flow out through the drainage holes. In addition, a hole is arranged on the bottom of motor housing and a first vent hole and a second vent hole are arranged on the front end cover. Based upon this structural design, the invention can meet the rainproof requirement and break through the application limitation of traditional unenclosed motor structure.

The foregoing descriptions are merely embodiments of the invention, and therefore do not mean to limit the scope of the invention. Any implementations on the content of the present specification by using an alternative structure or equivalent process transformation or direct or indirect application in the same field or in other related technical fields are in the protection scope of the invention.

What is claimed is:

1. An air-cooled rainproof motor structure, comprising a front end cover, a motor housing, a motor stator, a motor rotor, a shaft, a rear end cover, an axial fan and a fan housing; wherein the motor stator and the motor rotor are arranged inside the motor housing; the motor rotor is arranged inside the motor stator; the front end cover is connected with the front end of the motor housing through the shaft; the rear end cover is connected with the back end of the motor housing through the shaft; the axial fan is connected with the rear end cover through the shaft; the axial fan is surrounded by the fan housing; the front end cover is provided with vent holes which comprise a first vent hole and a second vent hole; and the rear end cover is also provided with vent holes; the front end cover comprises a pump connection side, a motor connection side and a middle part.

2. The air-cooled rainproof motor structure as described in claim 1, wherein the axial fan blows cold air through the vent hole of the rear end cover into the motor so as to cool down the motor stator and the motor rotor directly, after which the hot air is discharged from the vent holes of the front end cover.

3. The air-cooled rainproof motor structure as described in claim 1, wherein part of the cold air is directly blown onto the motor housing, so as to cool down the motor housing.

4. The air-cooled rainproof motor structure as described in claim 1, wherein the middle part of the front end cover is provided with a rainproof baffle, and a drainage hole is arranged on the bottom of the middle part.

5. The air-cooled rainproof motor structure as described in claim 1, wherein the middle part of the front end cover is provided with a second vent hole, so as to discharge the hot air from the motor.

6. The air-cooled rainproof motor structure as described in claim 1, wherein the motor connection side of the front end cover is provided with a first vent hole, so as to discharge the hot air from the motor.

7. The air-cooled rainproof motor structure as described in claim 1, wherein the rear end of the fan housing is provided with a third vent hole.

8. The air-cooled rainproof motor structure as described in claim 1, wherein a hole is arranged on the bottom of the fan housing.
